(19) United States
(12) Patent Application Publication
(10) Pub. No.: US 2026/0310397 A1
(43) Pub. Date: Oct. 8, 2026

(54) SYSTEM AND METHOD FOR VIDEO CONFERENCING ON A DUAL SCREEN TELEVISION

(71) Applicant: Telly, Inc., Sherman Oaks, CA (US)

(72) Inventors: Ilya Pozin, Los Angeles, CA (US); Sascha Prueter, Daellikon (ZH); Benjamin Hickman, Los Angeles, CA (US); Eric Loes, Seattle, WA (US); Rex Ching, Santa Clara, CA (US); John Hwang, Costa Mesa, CA (US); Joseph Yao Hua Chu, San Jose, CA (US); Shervin Pishevar, Miami, FL (US)

(21) Appl. No.: 19/483,212

(22) PCT Filed: May 9, 2024
(86) PCT No.: PCT/US2024/028623

§ 371 Date: Nov. 10, 2025

Related U.S. Application Data
(60) Provisional application No. 63/465,202, filed on May 9, 2023.

(51) Int. Cl. G06F 3/14; G06F 3/0482; G06F 3/0484; G06F 3/16; H04R 1/02

(52) U.S. Cl. CPC G06F 3/1446; G06F 3/0482; G06F 3/0484; G06F 3/165; H04R 1/028; H04R 2430/01; H04R 2499/15

(57) ABSTRACT

System and method for video conferencing on a dual screen television are disclosed. A disclosed television system comprises a housing, a primary screen in the housing configured to display first content including linear digital content, a secondary screen in the housing configured to display second content and having a height less than the primary screen, an audio source disposed in the housing configured to output audio associated with at least one of the first content and the second content, a user input device configured to receive one or more user commands, and a processor. The processor is configured to display the first content on the primary screen and the second content associated with a video conference on the secondary screen at the same time.

### CROSS-REFERENCE TO RELATED APPLICATIONS

This application claims the benefit of U.S. Provisional Patent Application No. 63/465,202 filed May 9, 2023 entitled “SYSTEM AND METHOD FOR AN INTEGRATED DUAL SCREEN TELEVISION WITH VIDEO CONFERENCING,” which is incorporated by reference herein in its entirety.

### TECHNICAL FIELD

The present application relates to television displays and, more particularly, to a television that integrates two display portions in a vertical stack that includes an integrated camera to enable video conferencing on one screen while program content is simultaneously active on the other screen.

### BACKGROUND

The proliferation of streaming video applications and the availability of video content online, has led to increased demands being placed on televisions to display traditional television content and make additional streaming or internet-based content available to television users.

Video conferencing applications have proliferated, and some allow video conferencing on a television. However, none allow use of a television screen without interruption during a video conference call.

Existing televisions use clumsy control and screen overlays designed to allow a user to interact with the television using a simple remote control to make viewing and content choices. These screen overlays only provide a limited amount of control, may interfere with viewing a currently displayed television program, particularly for others in the room, and do not lend themselves well to providing enhanced interactive features for the full range of possible interactive content and activities, including video conferencing.

Existing televisions generally have incorporated a single display screen to present television content to users. Some televisions have allowed picture in picture for watching programs while navigating menus and split screen functionality that allows users to watch more than one television program at a time. However, this functionality has generally been limited to displaying programs and menus in the same display at a reduced size. Televisions have also been arranged in arrays to allow single television sets to be physically placed in an array to each display part of a larger picture that is captured in the entire array.

There is a need for a television that allows the presentation of a television program or video conferencing content in addition to interactive content, control features and ancillary functionality in such a manner that the additional content, features and functionality do not interfere with the television program. There is a further need for a video conferencing capability that is active and fully functional on one screen without interfering with currently active content being presented on the television.

### SUMMARY

According to some embodiments of the present disclosure, a camera on the front of a television system is used to capture viewers for a video conference capability. The video conference capability allows viewers of television content on a primary screen of an integrated dual screen television system to receive a video call from or place a video call to other people on a secondary screen without interfering with the television content on the primary screen.

According to some embodiments of the present disclosure, the video conference call may occur in the secondary screen, and may enable people to interact via the video conference while watching the same content or different content. In addition, a setting could enable a speaking person to appear on listeners' primary screen with all listeners' are shown on the secondary screen. The video conference participants may be related to the gallery show on the secondary screen. For example, one could join other linear feed viewers specific to a region or age group or other arbitrary group definition.

According to some embodiments, the television system may display widget cards and advertisement cards on the secondary screen with the video conference. The video conferencing application may in some embodiments only launch calls to contacts associated with users who the processor determines are currently viewing the television program or the television system.

Some embodiments of the present disclosure are directed to a television system having a housing, a primary screen in the housing, the primary screen configured to display first content, the first content including linear digital content, a secondary screen in the housing, the secondary screen configured to display second content, the secondary screen having a height less than the primary screen, an audio source disposed in the housing, the audio source configured to output audio associated with at least one of the first content and the second content, a user input device configured to receive one or more user commands, and a processor. The processor is configured to display the first content on the primary screen; and while displaying the first content on the primary screen: display a video conferencing application on the secondary screen to a user, determine a video conferencing configuration associated with the user, in accordance with a determination that the video conferencing application is active, present one or more video conferencing options to the user on the secondary screen based on the video conferencing configuration, receive a video conference launch command from the user input device, the video conference launch command indicating a selection of the user regarding the one or more video conferencing options, and launch a video conference on the secondary screen based on the video conference launch command.

Some embodiments of the present disclosure are directed to a method of operating a television system, the method including displaying first content on a primary screen, the first content including linear digital content; and while displaying the first content on the primary screen: displaying a video conferencing application on a secondary screen to a user, wherein the primary screen and the secondary screen are integrated in a housing of the television system, determining a video conferencing configuration associated with the user, in accordance with a determination that the video conferencing application is active, presenting one or more video conferencing options to the user on the secondary screen based on the video conferencing configuration, receiving a video conference launch command from a user input device of the television system, the video conference launch command indicating a selection of the user regarding the one or more video conferencing options, and launching a video conference on the secondary screen based on the video conference launch command.

### BRIEF DESCRIPTION OF THE FIGURES

The above described features and advantages of the present disclosure will be more fully appreciated with reference to the following figures.

FIG. 1 depicts a television system that includes a primary screen, a secondary screen, and an audio source, according to embodiments of the present disclosure.

FIG. 2 depicts a functional block diagram of a television system that integrates video conferencing on a primary screen and/or a secondary screen of the television system, according to embodiments of the present disclosure.

FIGS. 3A-3E depict an exemplary process for configuring and presenting video conferencing on a secondary screen of a television system that integrates two distinct screens, according to embodiments of the present disclosure.

FIG. 4 depicts a functional block diagram of a video conferencing program that enables users to launch a video conferencing session on a secondary screen of a television system with third parties, while consuming content on the primary screen of the television system, according to embodiments of the present disclosure.

FIG. 5 depicts an illustrative view of watching content on a primary screen of a television system while video conferencing, widget and advertising feeds presented on a secondary screen of the television system, according to embodiments of the present disclosure.

FIG. 6 depicts an illustrative view of video conferencing on both a primary screen and a secondary screen of a television system, allowing an active speaker in a call to be on the primary screen while a gallery of other callers are displayed on the secondary screen, according to embodiments of the present disclosure.

FIG. 7 depicts an exemplary method for video conferencing using a television system that integrates two distinct screens, according to embodiments of the present disclosure.

### DETAILED DESCRIPTION

One or more embodiments of the present disclosure are directed to a television system having two screens that are integrally contained in a housing. One of the screens (e.g., the primary screen) is the main screen and the other screen (e.g., the secondary screen) is a smaller screen that may be used to provide video conferencing with third parties, along with widgets and advertising, while the user is also consuming content on the main screen. Users may accordingly interact with others regarding content that one or more video conferencing parties are currently consuming.

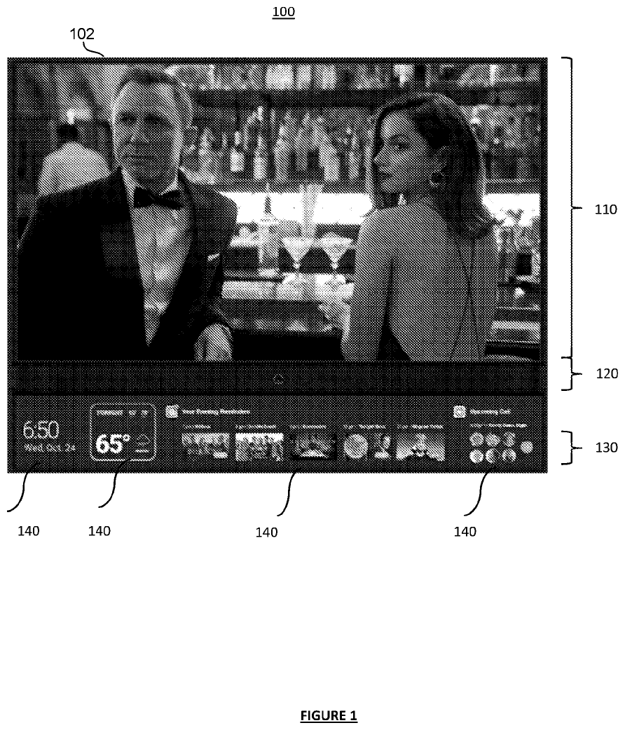

FIG. 1 depicts a television system 100 that integrates two distinct screens and concurrent functionality according to one or more embodiments of the present disclosure.

Referring to FIG. 1, the television system 100 includes an overall housing 102, a primary screen 110, and a secondary screen 130. The primary screen 110 and the secondary screen 130 may be separated by an audio source 120. The audio source 120 may be a sound bar or speaker. In some embodiments, the audio source 120 is disposed between the primary screen 110 and the secondary screen 130.

In some embodiments, the primary screen 110 and the secondary screen 130 may be separated by a physical divider or placed adjacent to one another. The secondary screen 130 may be portioned into areas or elements where the screen output is determined by widget programs 140, that present information, interactions, or other information to users.

The primary screen 110 and the secondary screen 130 may be vertically stacked. For example, the primary screen 110 may be vertically disposed above the secondary screen 130. In some embodiments, the primary screen 110 and the secondary screen 130 may be vertically stacked such that a central axis of the primary screen 110 also extends along the central axis of the secondary screen 130. In other words, the central axis of the primary screen 110 may bifurcate the secondary screen 130. In some embodiments, the audio source 120 may be disposed between the primary screen 110 and the secondary screen 130 such that the central axis of the primary screen 110 bifurcates the audio source 120 and the secondary screen 130.

According to embodiments of the present disclosure, the secondary screen 130 is approximately ¼ to ⅓ the height of the primary screen 110, which preferably has an aspect ratio of 16:9. This allows a television viewer or user to watch a standard 16:9 TV screen (e.g., the primary screen 110) while simultaneously watching a smaller, lower screen (e.g., the secondary screen 130) for multitasking. In some embodiments, the secondary screen 130 has a width substantially the same as the primary screen 110, but a height that is a percentage of the primary screen 110. For example, the secondary screen 130 may have a height that is 10% to 90%, 20% to 80%, 30% to 70%, or 40% to 60% the height of the primary screen 110. In some embodiments, the audio source 120 has a width less than the width of the primary screen 110 and secondary screen 130. In alternative embodiments, the audio source 120 has a width greater than or equal to the width of the primary screen 110 and secondary screen 130.

Additionally, the secondary screen 130 can be on while leaving the primary screen 110 off for media consumption including text, graphics, advertising, video, and audio. This arrangement facilitates providing a full range of interactive content, control and features to users via the provision of applications that may control either screen or both screens simultaneously. Such applications enable the linking of content, control and features between the two screens and ancillary devices such a sound bar, which may also be integrated into the television system 100.

The primary screen 110 may be configured to display first content and the secondary screen 130 may be configured to display second content. The first content may be linear digital content, which may be dynamic content related to television programs or video streaming services. The second content may be different than the first content and may include communication content (e.g. video conferencing content), programming content, advertising content, or navigation content. In some embodiments, a user interacts with the second content on the secondary screen 130 while watching the first content on the primary screen 110 at the same time.

According to some embodiments, the integrated television screens (e.g., the primary screen 110 and the secondary screen 130) may comprise separate television panels integrated into a single television, with or without a soundbar. In other embodiments, for example, a single 4:3 panel may be configured with a physical screen divider and hardware and software provisioning to divide the television system 100 into two separate integrated screens. According to one embodiment, HDMI ports may deliver video to the primary screen 110 only. In other embodiments, the HDMI ports may deliver video to both the primary screen 110 and the secondary screen 130.

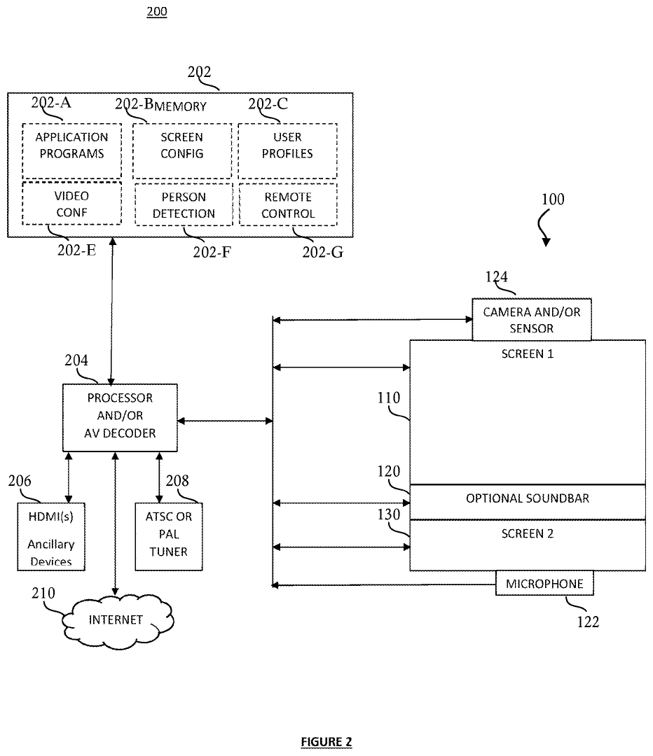

FIG. 2 depicts a functional block diagram of a television system, e.g. the television system 100 in FIG. 1, according to embodiments of the present disclosure. As illustrated in FIG. 2, the television system 100 may include a processor 204 coupled with a memory 202, HDMI ports 206, an ATSC or PAL tuner 208, a camera and/or sensor 124, a microphone 122, speakers or an optional soundbar (e.g., the audio source 120), the Internet 210, and two distinct screens (e.g., the primary screen 110 and the secondary screen 130), as described above. The memory 202 may store programs that include program instructions that are executed by the processor 204 to enable the various functionalities of the television system. The memory 202 may include, for example, application programs 202-A, a screen configuration program 202-B, a user profile program 202-C, a video conference program 202-E, a person detection program 202-F, and a remote control program 202-G, among others.

The HDMI ports 206 enable A/V devices to be connected to the television system 100, including DVD players, DVRs, sound bars, streaming boxes, A/V Receivers, gaming consoles and other equipment. ATSC or PAL tuners 208 may be incorporated into the television system 100 to allow the television system 100 to receive over the air or certain cable broadcasts and present them on the primary screen 110, or on the secondary screen 130.

A microphone 122 may be included in the television system 100, such as within the housing 102 to allow the user to provide spoken commands to the television system 100, to allow for video conferencing, and to allow other audio visual applications. A camera and/or sensor 124 may also be provided to facilitate functionality such as determining the number of viewers of the television system 100, to permit video conferencing, to identify viewers, and for gesture and motion recognition, among other features. The screens (e.g., primary screen 110 and secondary screen 130) are distinct and render images corresponding to content from the HDMI ports 206, from the tuners 208, from the Internet 210, streaming or other interconnected devices. In addition, the content of the screens may be determined by application programs or any of the other programs stored in memory 202 and executed by the processor 204. The audio source 120 (e.g. speakers and/or optional soundbar) is used to provide audio output corresponding to content displayed on the screens or enabled through the application programs or other programs provided on the television system 100. The television system 100 may also incorporate a RF receive or RI port for receiving signals from a remote control used to control the television system 100.

The processor 204 may be a single microprocessor, multiple processors, or a processor and a co-processor. In one embodiment, a primary microprocessor may be used to render and operate the user interface while a second processor may be used to decode video, for example H.264 format outputting a signal via HDMI. The processor(s) 204 may support all functionality needed to operate the display screens of the television system 100, and synchronize images with audio output, including rendering, video decoding, audio decoding, audio visual synchronization control, motion estimation and motion compensation, picture quality, time stamp normalization, frame rate control, and over the air updates. In addition, the processor(s) 204 executes program instructions from memory to enable applications to be presented on one or both screens of the television system 100, and to permit use of the speakers, microphone, cameras, internet connection, remote control, and two-way communication with ancillary devices connected to the television, such as content streaming hardware.

According to embodiments of the present disclosure, the processor 204 may be an application processor designed specifically for smart display applications, and may include, for example, CPU/GPU subsystems, video codecs, graphics subsystems, video engines, video/graphics output pipelines, HDMI receiver ports, demultiplexers for broadcast and streaming video, digital signal processors (DSPs) for processing audio, peripheral interfaces such as for Ethernet, USB, SDIO 3.0, eMMC 5.1, SDIO/SD card controller, UART, I2C, high-speed SPI PWMs and an RI blaster. The processor may be distributed or a system on a chip and may interface with additional memory and components of the television system 100.

The processor 204 may be configured to display first content on the primary screen 110. The first content may be content that the user desires to watch while the user interacts with second content being displayed on the secondary screen 130. For example, while displaying the first content on the primary screen 110, the processor displays a video conferencing application on the secondary screen 130 to a user. The processor 204 determines a video conferencing configuration associated with the user, in accordance with a determination that the video conferencing application is active.

In some embodiments, while displaying the first content on the primary screen 110, the processor receives a video conferencing activation command from a user input device. The user input device may be a remote control, mobile device, desktop computer, a wired device coupled to the television system 100, or a wireless device configured to wirelessly communicate with the television system 100. The video conferencing activation command may be an indication of a user command transmitted by the user input device of the user's desire and intention to access or activate the video conferencing application. In response to receiving the video conferencing activation command, the processor 204 determines that the video conferencing application is active, and determines a video conferencing configuration associated with the user, e.g. default or user-selected options for video conference settings, contact lists of the user for video conferencing, etc.

In some embodiments, while displaying the first content on the primary screen 110, the processor receives an incoming video conferencing call received through a port of the television system 100. In response to receiving the incoming video conferencing call, the processor 204 determines that the video conferencing application is active, and determines a video conferencing configuration associated with the user, e.g. default or user-selected options for answering or rejecting the incoming video conferencing call, a time period set to wait for the user to answer the incoming video conferencing call before ending the call, pre-screening setting to determine whether to reject the incoming video conferencing call automatically due to a reject contact list or a no-interruption setup for the first content on the primary screen 110, etc.

The processor 204, in accordance with a determination that the video conferencing application is active, may present one or more video conferencing options to the user on the secondary screen 130 based on the video conferencing configuration. The processor 204 may receive, such as from the user input device, a video conference launch command. The video conference launch command may indicate a selection of the user regarding the one or more video conferencing options, for example, to initiate an outgoing video conference call or answer an incoming video conference call. In response to receiving the video conference launch command, the processor 204 may launch a video conference to be displayed on the secondary screen 130, while displaying the first content on the primary screen 110 at the same time.

In some embodiments, the processor 204 present one or more interactive video conference features to the user on the secondary screen 130, while displaying the first content on the primary screen 110 at the same time. The processor 204 may receive a video conference interaction command from the user input device. The video conference interaction command indicates an interactive video conference feature selected by the user. For example, the interactive video conference features may include feature like: audio control, video control, volume adjustment, screen sharing, chat functions, etc. The user using the user input device may make a selection of a particular interactive video conference feature. In response to receiving the video conference interaction command, the processor may perform a video conference function associated with the particular interactive video conference feature on the secondary screen 130.

Referring back to FIG. 1, in some embodiments, a user may view content on the primary screen 110, while using the secondary screen 130 to have a video conference using some or all of the system components shown in FIG. 2. The video conference may be displayed on the secondary screen 130, without overlaying or obstructing the content of the primary screen 110. A user may interact with the first content on the primary screen 110 to change or adjust content on the primary screen 110, without overlaying or obstructing the video conference being displayed on the secondary screen 130. A user may also interact with the second content on the secondary screen 130 to change or adjust content on the primary screen 110, e.g. an active speaker in the video conference may be displayed on the primary screen 110 to replace the previously shown first content on the primary screen 110.

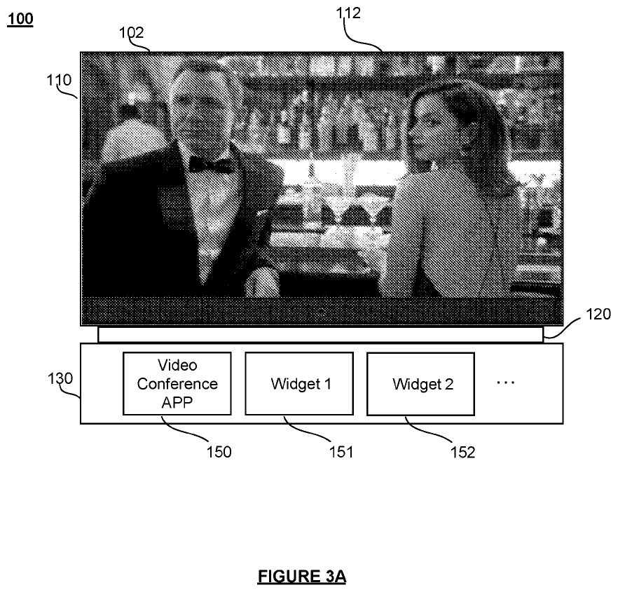

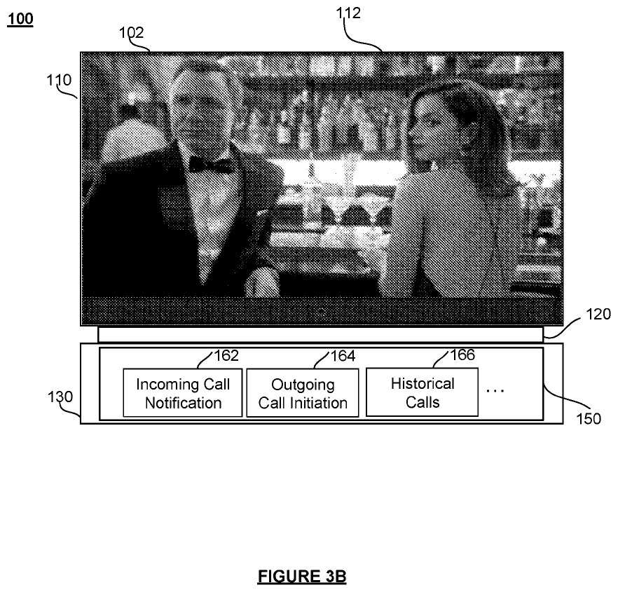

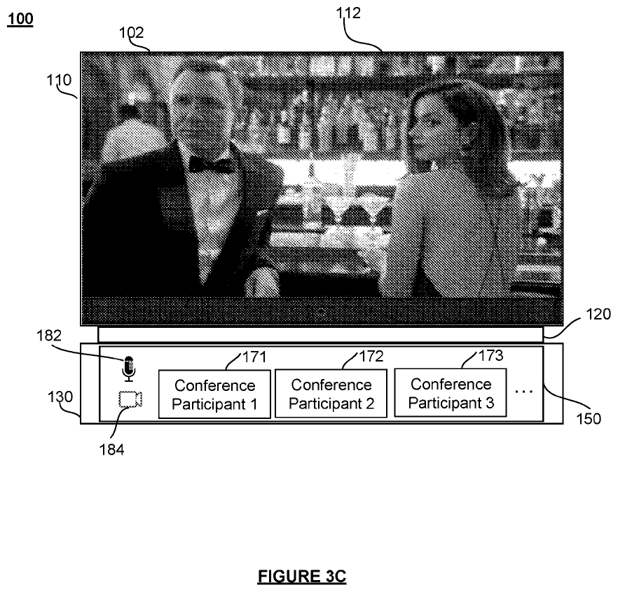

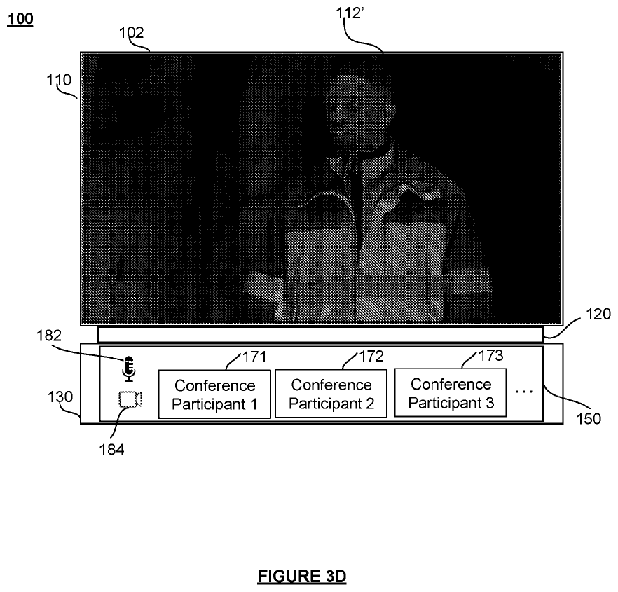

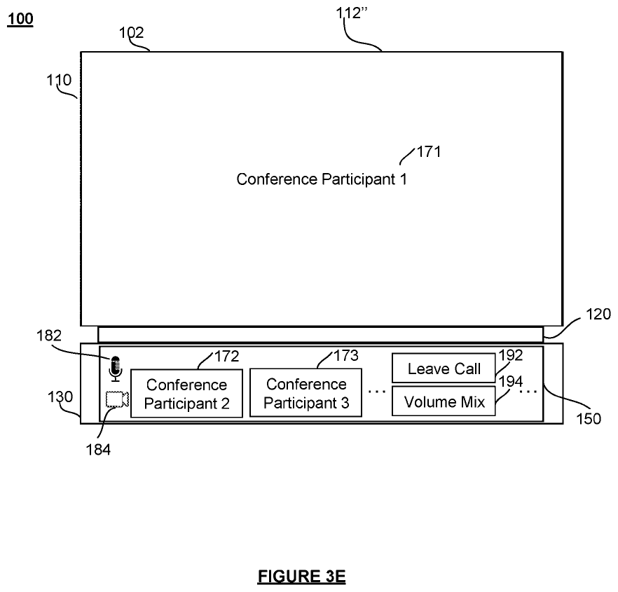

FIGS. 3A-3E depict an exemplary process for configuring and presenting video conferencing on a secondary screen of a television system, e.g. the television system 100 in FIG. 1, which integrates two distinct screens, according to embodiments of the present disclosure. Referring to FIG. 3A, the television system 100 may display first content, such as first content 112, on the primary screen 110 and one or more applications or widgets, such as video conference APP 150 and/or widgets 151, 152. The first content may come from an over the air source and the tuner, from an HDMI source, from a streaming source or another application running on the television system 100.

In some embodiments, a user, using a user input device, may select a desired application or widget. For example, a user may provide an video conferencing activation command to select the video conference APP 150 and access the video conference APP 150. For example, a user may use a user input device such as a remote control to transmit the video conferencing activation command to access the video conference APP 150 on the secondary screen 130. In some embodiments, the video conference APP 150 displays on a portion of secondary screen 130. As shown in FIG. 3B, selecting the video conference APP 150 results in the secondary screen 130 displaying (e.g. by booting up or loading) the video conference APP 150 to provide a user access to the video conference APP 150 while still displaying the first content 112 on the primary screen 110.

As shown in FIG. 3B, the video conference APP 150 may include a plurality of video conferencing options (e.g., an incoming call notification 162, an outgoing call initiation 164, historical calls 166, etc.) on the secondary screen 130 for a user to select to launch a video conference. In some examples, when an incoming call is waiting, the user may select answering the incoming call to launch a video conference, or rejecting the incoming call, based on options provided within the incoming call notification 162. Alternatively, the user may select the outgoing call initiation 164 to launch a video conference with one or more persons on the contact list, which may be provided within the outgoing call initiation 164. In some examples, the user may select the historical calls 166 to view data records (e.g. video recordings, transcripts, etc.) of historical conference calls.

In some embodiments, the first content 112 is displayed on the primary screen 110 in a high-definition format synchronized with audio presented on a speaker or sound bar associated with the television system 100, while the video conference APP 150 is displayed on the secondary screen 130 in a high-definition format and a size that is substantially the same width as the primary screen 110 but a smaller height than that of the primary screen 110.

In some embodiments, the video conference APP 150 includes program instructions stored in the memory 202 that, when executed by the processor 204, may be used to configure and launch video calls. The video conference APP 150 may use video conference configuration data stored in the memory 202 to store preferences. For example, the video conference APP 150, once launched, may bring up a scrollable list of contacts for the current viewer. Each contact may have associated with it a picture, name, phone number and/or alphanumeric address that may be used to launch a video conference call to that contact person or a video conference call to which the viewer has been invited. Similarly, the video conference APP 150 may receive a video conference call and launch the video conference APP 150 on the secondary screen 130 such that the user can join the call. Video conference calls in both directions may be established using, for example, the session interconnect protocol (SIP) in a manner to invite participants by sending invite messages to a telephone number or internet address, or calendar invitations with invite messages link to join a video call at a particular URL and particular time. Once established, the user's camera and microphone are used to create a video stream for other call participants, and the other participants' videos are streamed to the user's television on the secondary screen 130.

A user may provide a video conference launch command by a selection of one of the video conferencing options via the user input device. In some embodiments, the video conference launch command may be provided by a special button on a remote control or a voice command that launches the video conferencing application or widget. Alternatively, the user may navigate a television menu with the remote control or voice commands and select the video conferencing application. Based on the video conference launch command, a video conference is launched and displayed on the secondary screen 130, while still displaying the first content 112 on the primary screen 110, as shown in FIG. 3C.

As shown in the transition from FIG. 3B to FIG. 3C, the video conference is launched via video conferencing application to produce an interactive display on the secondary screen 130, while the first content 112 is still available to display on the primary screen 110. As shown in FIG. 3C, the video conference is launched in the video conference APP 150 with various interactive video conference features on the secondary screen 130. For example, the interactive video conference features include but not limited to: an audio control 182, a video control 184, and widgets 171, 172, 173 for conference participants. The audio control 182, once selected by a user, is configured to turn on, turn off, and control audio settings for the video conference. The video control 184, once selected by a user, is configured to turn on, turn off, and control video settings for the video conference. Each of the widgets 171, 172, 173 is configured to display a real-time video, a static image, or an icon for a corresponding participant of the video conference. In some embodiments, there could be any number of conference participants in the video conference.

As shown in the transition from FIG. 3C to FIG. 3D, the television system 100 supports to switch the concurrent content (e.g. from the first content 112 to content 112′) displayed on the primary screen 110, without overlaying or obstructing the content of the secondary screen 130. In some embodiments, the user can use the user input device, e.g. using a dedicated button on a remote control or a voice command via microphone, to browse applications to launch on the primary screen 110 while maintaining all functionalities and features within the video conference displayed on the secondary screen 130.

In some embodiments, as shown in the transition from FIG. 3D to FIG. 3E, the television system 100 further supports to switch the concurrent content (e.g. from the first content 112 or the content 112′ to content 112″) displayed on the primary screen 110, while still displaying the video conference on the secondary screen 130. In some embodiments, based on a default configuration or pre-configuration of the video conference APP 150 by the user, the primary screen 110 can display an active speaker in the video conference, while maintaining all functionalities and features other than the active speaker widget of the video conference displayed on the secondary screen 130. The active speaker may be automatically rotated based on who is currently speaking in the video conference. In the example shown in FIG. 3E, the conference participant 1 is an active speaker in the video conference. As such, the widget 171 for the conference participant 1 is now displayed to show a real-time video, a static image, or an icon for the conference participant on the primary screen 110 as the content 112″, by replacing the previously displayed content 112 or 112′, while the other features of the video conference is still displayed on the secondary screen 130. For example, while the primary screen 110 displays the active speaker of the video conference, the secondary screen 130 displays a gallery of non-active speakers or other guests of the video conference, along with additional features and options related to the video conference.

In the example shown in FIG. 3E, while displaying the conference participant 1 as an active speaker of the video conference on the primary screen 110, the secondary screen 130 displays: a gallery of widgets 172, 173 showing non-active speakers or other guests of the video conference, the audio control 182, the video control 184, a leave call option 192, and a volume mix option 194. The leave call option 192, once selected by the user, is configured to end the video conference on the television system 100 for the user. The volume mix option 194, once selected by the user, is configured to adjust application audio gain to control volumes for the contents displayed on the primary screen 110 and the secondary screen 130. In some examples, the volume mix option 194 allows the user to adjust a percentage of the current volume allocated for individual application concurrently displayed on the primary screen 110 and the secondary screen 130, e.g. a streaming APP displayed on the primary screen 110 or the video conference APP 150 displayed on the secondary screen 130. In some embodiments, when both applications on the primary screen 110 and the secondary screen 130 have audio, by default they both have a 100% volume, i.e. at the same volume level. If a user desires, the user can adjust this gain to a desired output to provide a blended audio experience to hear both the content displayed on the primary screen 110 and the video conference displayed on the secondary screen 130.

In some embodiments, the secondary screen 130 can display further interactive video conference features like screen sharing, chat functions, etc. For example, once receiving a video conference interaction command from the user input device indicating an interactive video conference feature selected by the user, the television system 100 performs a video conference function associated with the interactive video conference feature on the secondary screen 130 based on the video conference interaction command.

In some embodiments, any video conference related content, other than an active speaker, may be displayed on the primary screen 110, while displaying the remaining features of the video conference on the secondary screen 130. For example, once receiving an automatic switch command from the user input device indicating a user desire to automatically switch content displayed on the primary screen 110 between a linear digital content (e.g. content of a streaming APP) and video conference related content, the television system 100 automatically switches the content displayed on the primary screen 110 from the linear digital content to the video conference related content, in accordance with a determination that a predetermined function is activated in the video conference. The predetermined function is one of: a screen sharing function, an active speaker displaying function, a notification function, an incoming call function. For example, if the screen sharing function is activated and the user sends an automatic switch command, the primary screen 110 displays a shared screen of the video conference, by replacing previously displayed content (e.g. a linear digital content of a streaming APP or an active speaker), while maintaining other features of the video conference displayed on the secondary screen 130. When multiple predetermined functions are activated, a pre-configuration or pre-selection based on priorities of these functions can be used to determine what content to be displayed on the primary screen 110. In some examples, in accordance with a determination that the predetermined function is deactivated in the video conference, the television system 100 can automatically switch the content displayed on the primary screen 110 from the video conference related content to the linear digital content or whatever content previously displayed on the primary screen 110.

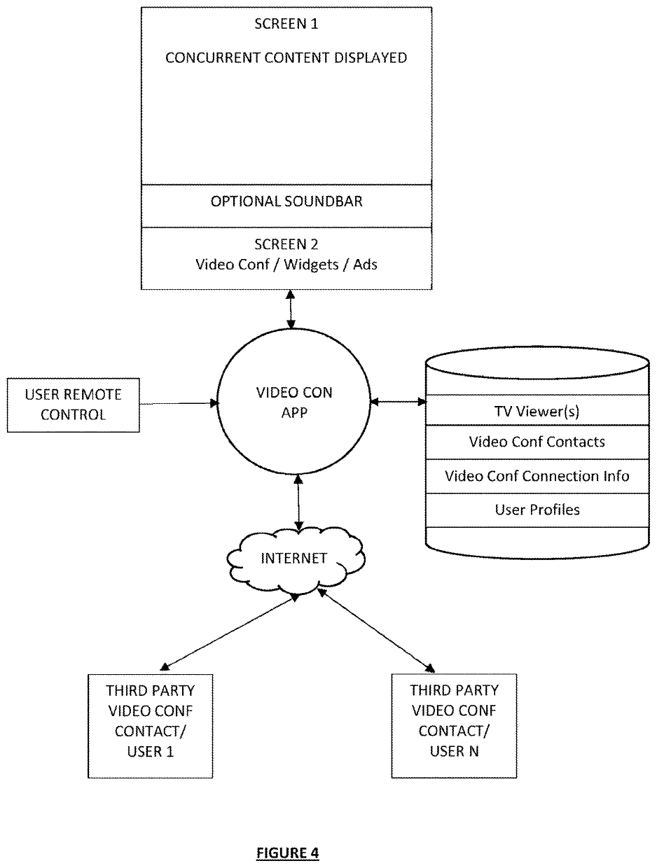

FIG. 4 depicts a functional block diagram of a video conferencing program that enables users to launch a video conferencing session on a secondary screen of a television system (e.g. the secondary screen 130 of the television system 100) with third parties, while consuming content on a primary screen of the television system (e.g. the primary screen 110 of the television system 100), according to embodiments of the present disclosure. Referring to FIG. 4, a remote control (or virtual remote or microphone in some embodiments) is used to interact with the television system 100 to determine content displayed on the primary screen 110 and other content displayed on the secondary screen 130, including application widgets, advertisement widgets, and video conference application options. For example, based on a selection of the user via the remote control, the video conference application uses video conferencing related data to enable interaction with the user on the secondary screen 130. The video conferencing related data may include: current TV viewers of the primary screen 110, video conference contacts for users of the primary screen 110, video conference connection information, and video conferencing user profiles, which may include video conference preferences, subscriptions, and other information used to set up and launch video conference calls.

In some embodiments, the video conference application may send conference invitations by the SIP protocol, SMS, text message, email or another form of digital communication. Once a video conference session is established, the video conference application program may direct the audio and visual signals to the secondary screen 130 and the speakers (or optional sound bar) of the television system 100. The video conference application may permit audio from the video conference to be sent to the speakers (or optional sound bar) of the television system 100 even as the speakers being used to present audio from the content concurrently being shown on the primary screen 110. The 100 may blend the audio from contents concurrently being watched with the video conference application on the secondary screen 130 and an application on the primary screen 110, and enable the ability to individually control the audio gain and volume levels for the concurrently watched contents.

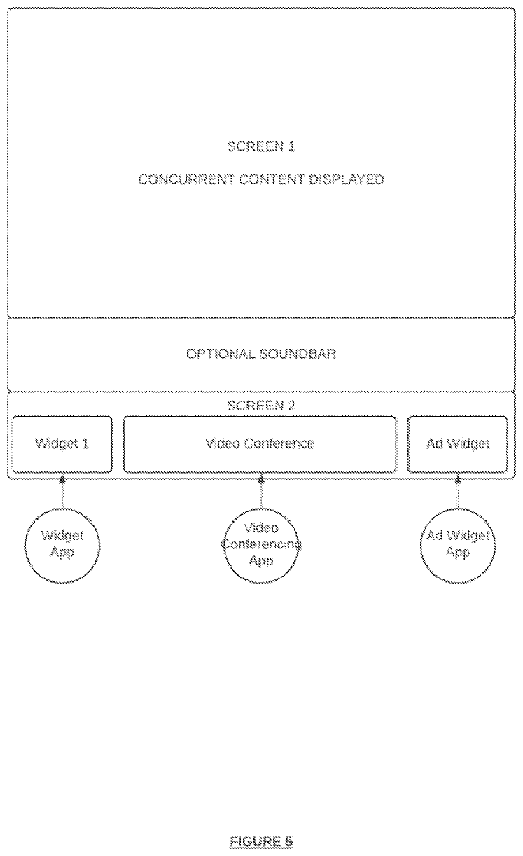

FIG. 5 depicts an illustrative view of watching content on a primary screen of a television system (e.g. the primary screen 110 of the television system 100) while video conferencing, widget and advertising feeds presented on a secondary screen of the television system (e.g. the secondary screen 130 of the television system 100), according to embodiments of the present disclosure. In some embodiments, in addition to presenting the video for the video conference on the secondary screen 130, the processor of the television system 100 may concurrently execute widgets and advertisement applications that simultaneously present widgets and ads on the secondary screen 130, along with the video conference. As shown in FIG. 5, a widget card (Widget 1) providing information is placed next to the video conference content, which is in turn next to an ad widget card in the secondary screen 130. All and different variations of the arrangement of different widgets on the secondary screen 130 are within various embodiments of the present disclosure.

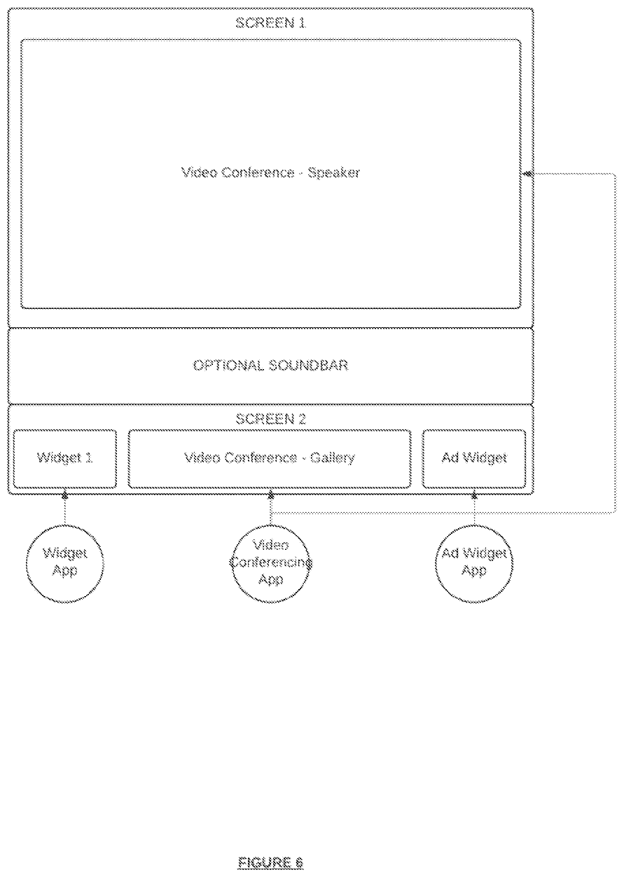

FIG. 6 depicts an illustrative view of video conferencing on both a primary screen and a secondary screen of a television system (e.g. the primary screen 110 and the secondary screen 130 of the television system 100), allowing an active speaker in a call to be on the primary screen while a gallery of other callers are displayed on the secondary screen, according to embodiments of the present disclosure. As shown in FIG. 6, pursuant of a dual screen video conferencing solution where the active speaker is on the primary screen 110, the television system 100 can rotate the active speaker based on who is currently speaking in the video conference. The 130 continues to show the non-active speaker gallery of other guests on the video call along with a widget and ad widget experience.

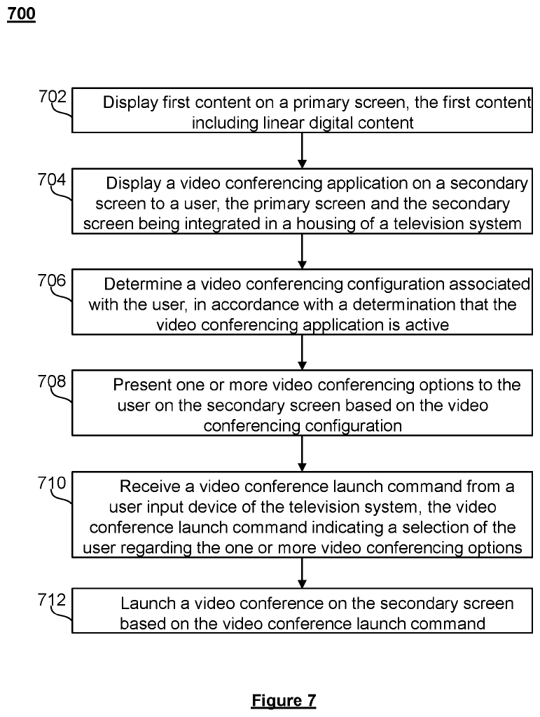

FIG. 7 is a flowchart illustrating an exemplary method 700 for operating a television system, such as the television system shown in FIGS. 1-3, according to embodiments of the present disclosure.

At operation 702, a processor (e.g., processor 204) may display first content on the primary screen 110. For example, as shown in FIG. 3A, the primary screen 110 may display the first content 112. The primary screen 110 may be disposed within a housing 102 and the first content 112 may be linear digital content. In some embodiments, all the other operations 704~712 in the method 700 are performed while displaying the first content 112 on the primary screen 110.

At operation 704, while displaying the first content on the primary screen 110, the processor 204 may display second content (e.g. a video conferencing application) on the secondary screen 130 to a user. For example, as shown in FIG. 3A, the primary screen 110 and the secondary screen 130 are integrated in the housing 102 and separated by an audio source 120 of the television system 100. In some examples, the secondary screen 130 has a height less than the primary screen 110. In some examples, the audio source 120 is disposed in the housing, and configured to output audio associated with at least one of the first content and the second content. As shown in FIG. 3A, the processor 204 may display a video conferencing application 150 on the secondary screen 130 to a user, while displaying the first content 112 on the primary screen 110.

In some embodiments, the secondary screen 130 is different than the primary screen 110. For example, the secondary screen 130 may be vertically coupled to the primary screen 110 such that the primary screen 110 and the secondary screen 130 are vertically arranged in series. In some embodiments, an audio source (e.g., the audio source 120) is disposed between the primary screen 110 and the secondary screen 130. The secondary screen 130 may be disposed in the housing and may have a height less than the height of the primary screen 110. In some embodiments, because the secondary screen 130 may have different sizes and aspect rations, the processor 204 may adjust the video conference APP 150 to fit the display of the secondary screen 130 based on configuration settings (e.g., aspect ratio, sharpness, brightness, color saturation) stored in memory of the television system 100.

In some embodiments, the primary screen 110 and the secondary screen 130 are located on two television panels respectively. The two television panels are integrated in the housing 102, and are separated by the audio source 120 (e.g. a sound bar) in the housing 102. In some embodiments, the primary screen 110 and the secondary screen 130 are integrated on a single television panel in the housing 102. The single television panel is divided into the primary screen 110 and the secondary screen 130 by a physical screen divider or a software configuration divider.

In some embodiments, the television system 100 further comprises: a camera 124 configured to: determine a quantity of current users of the television system 100, identify the current users, permit video conferencing, and gesture and motion recognition of the current users; a microphone 122 for capturing sound and voice commands from the current users of the television; a wireless communication port (e.g. RF port) configured to receive signals and user commands from a remote control for controlling both the primary and secondary screens; and at least one audio-video port (e.g. HDMI port 206) configured to convey the first content and the second content.

At operation 706, while displaying the first content on the primary screen 110 as shown in FIG. 3A, the processor 204 may determine a video conferencing configuration associated with the user, in accordance with a determination that the video conferencing application is active. In some embodiments, the video conferencing application is determined to be active based on at least one of: a video conferencing activation command received from the user input device to indicate a user desire to activate the video conferencing application; and an incoming video conferencing call received through a port of the television system 100. The user input device includes at least one of the microphone and the remote control. In some embodiments, the television system 100 may determine an identity of the user based on the camera or account information provided by the user, and then determines the video conferencing configuration pre-configured for the user associated with the user account.

At operation 708, the processor may present one or more video conferencing options to the user on the secondary screen 130 based on the video conferencing configuration. For example, as shown in FIG. 3B, the video conferencing options include options of the incoming call notification 162, the outgoing call initiation 164, and the historical calls 166. The user may select one of the incoming call notification 162 and the outgoing call initiation 164 in order to launch a video conference on the secondary screen 130, while the first content 112 being displayed on the primary screen 110.

At operation 710, the processor 204 receives a video conference launch command from a user input device of the television system 100. At operation 712, the processor 204 may launch a video conference on the secondary screen 130 based on the video conference launch command. The video conference launch command indicates a selection of the user regarding the one or more video conferencing options. For example, as shown in FIG. 3B, the user may select the outgoing call initiation 164 for launching an outgoing video conference call. In response to the selection, the processor 204 can determine a list of contacts of the user who is determined to be currently viewing the television system 100, present the list of contacts to the user on the secondary screen 130, and launch, based on the video conference launch command, the outgoing video conference call on the secondary screen 130 as shown in FIG. 3C. The outgoing video conference call can invite one or more contacts in the list. In some embodiments, the user may select the incoming call notification 162 for accepting an invitation from a contact in the list, to start a video conference.

In some embodiments, each contact in the list is associated with the following information stored in the memory: picture, name, phone number, alphanumeric address to be used to launch a video conference involving the contact. The video conferencing application uses video conferencing related data to enable an interaction with the user on the secondary screen 130. The video conferencing related data includes: current television users, video conference contacts for the current television users, video conferencing user profiles for the current television users. Each video conferencing user profile for a corresponding television user includes: video conference preferences, subscriptions, and other information used to set up and launch video conferences for the corresponding television user. In some embodiments, the user may select the incoming call notification 162 for accepting an invitation from a contact in the list, to start a video conference.

In some embodiments, as shown in FIG. 3C, while displaying the first content 112 on the primary screen 110, the processor 204 presents one or more interactive video conference features (e.g. the audio control 182, the video control 184, and the conference participant widgets 171~173) to the user on the secondary screen 130. In response to receiving a video conference interaction command from the user input device indicating an interactive video conference feature selected by the user, the processor 204 can perform a video conference function associated with the interactive video conference feature on the secondary screen 130 based on the video conference interaction command.

In some embodiments, as shown in FIG. 3C and FIG. 3D, while displaying the video conference on the secondary screen 130, the television system 100 receives a television control command from the user input device indicating a user desire to control or change the first content 112 on the primary screen 110. In response to receiving the television control command, the processor 204 can perform a television control function to control or change the first content 112 (e.g. from the first content 112 in FIG. 3C to the content 112′ in FIG. 3D) on the primary screen 110 based on the television control command, without overlaying or obstructing the content on the secondary screen 130.

In some embodiments, as shown in FIG. 3D and FIG. 3E, while displaying the video conference on the secondary screen 130, the television system 100 receives an automatic switch command from the user input device indicating a user desire to automatically switch content displayed on the primary screen 110 between linear digital content (e.g. the first content 112 in FIG. 3C or the content 112′ in FIG. 3D) and video conference related content (e.g. the content 112″ in FIG. 3E). In some embodiments, the television system 100 automatically switches the content displayed on the primary screen 110 from the linear digital content to the video conference related content, in accordance with a determination that a predetermined function is activated in the video conference, and automatically switches the content displayed on the primary screen 110 from the video conference related content to the linear digital content, in accordance with a determination that the predetermined function is deactivated in the video conference. The predetermined function may be one of: a screen sharing function, an active speaker displaying function, a notification function, or an incoming call function.

In some embodiments, as shown in FIG. 3E, while displaying content on the primary screen 110, the television system 100 also displays software widgets 192, 194 on the secondary screen 130 together with the video conference. As shown in FIG. 5, the television system 100 may also display an advertising widget on the secondary screen 130 together with the video conference. As shown in FIG. 5, at least one of the software widgets is displayed next to the video conference on the secondary screen 130, and the advertising widget is displayed next to the video conference on the secondary screen 130.

In some embodiments, while displaying the first content 112 on the primary screen 110 and displaying the video conference on the secondary screen 130, the television system 100 receives an audio gain adjustment command from the user input device indicating a user desire to adjust percentages of audio volumes allocated for the first content 112 on the primary screen 110 and the video conference on the secondary screen 130, respectively. For example, the user may select the volume mix option 194 in FIG. 3E to send the audio gain adjustment command. In response, the television system 100 can adjust the audio volumes for the first content 112 on the primary screen 110 and the video conference on the secondary screen 130 based on the audio gain adjustment command, to provide a blended audio output for both the primary and secondary screens.

In some embodiments, while displaying the first content 112 on the primary screen 110, the processor 204 determines a closed captioning language based on configured language information for television users stored in the memory 202 and the current television users, and displays closed captioning data on the secondary screen 130 based on the closed captioning language. In some embodiments, the television system 100 may display closed captioning data on both the primary and secondary screens. In some embodiments, the closed captioning data is synchronized between the secondary screen 130 and the corresponding video presented on the primary screen 110.

While particular embodiments have been shown and described herein, it will be understood by those having ordinary skill in the art that changes may be made to those embodiments without departing from the spirit and scope of the present disclosure.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMS, ROMS, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIGS. 3 and 6, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 5.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A television system, comprising:
a housing;
a primary screen in the housing, the primary screen configured to display first content, the first content including linear digital content;
a secondary screen in the housing, the secondary screen configured to display second content, the secondary screen having a height less than the primary screen;
an audio source disposed in the housing, the audio source configured to output audio associated with at least one of the first content and the second content;
a user input device configured to receive one or more user commands; and
a processor configured to:
display the first content on the primary screen; and
while displaying the first content on the primary screen:
display a video conferencing application on the secondary screen to a user,
determine a video conferencing configuration associated with the user, in accordance with a determination that the video conferencing application is active,
present one or more video conferencing options to the user on the secondary screen based on the video conferencing configuration,
receive a video conference launch command from the user input device, the video conference launch command indicating a selection of the user regarding the one or more video conferencing options, and
launch a video conference on the secondary screen based on the video conference launch command.

2. The television system of claim 1, wherein the video conferencing application is determined to be active based on at least one of:
a video conferencing activation command received from the user input device, the video conferencing activation command indicating a user desire to activate the video conferencing application; and
an incoming video conferencing call received through a port of the television system.

3. The television system of claim 1, wherein the processor is further configured to:
while displaying the first content on the primary screen:
present one or more interactive video conference features to the user on the secondary screen,
receive a video conference interaction command from the user input device, the video conference interaction command indicating an interactive video conference feature selected by the user, and
perform a video conference function associated with the interactive video conference feature on the secondary screen based on the video conference interaction command.

4. The television system of claim 1, wherein the processor is further configured to:
while displaying the video conference on the secondary screen:
receive a television control command from the user input device, the television control command indicating a user desire to control or change the first content on the primary screen, and
perform a television control function to control or change the first content on the primary screen based on the television control command.

5. The television system of claim 1, wherein the processor is further configured to:
while displaying the video conference on the secondary screen:
receive an automatic switch command from the user input device, the automatic switch command indicating a user desire to automatically switch content displayed on the primary screen between the linear digital content and video conference related content,
automatically switch the content displayed on the primary screen from the linear digital content to the video conference related content, in accordance with a determination that a predetermined function is activated in the video conference, and
automatically switch the content displayed on the primary screen from the video conference related content to the linear digital content, in accordance with a determination that the predetermined function is deactivated in the video conference, wherein the predetermined function is one of: a screen sharing function, an active speaker displaying function, a notification function, an incoming call function.

6. The television system of claim 1, wherein the processor is configured to:
while displaying the first content on the primary screen:
determine a list of contacts of the user who is determined to be currently viewing the television system,
present the list of contacts to the user on the secondary screen, and
launch, based on the video conference launch command, the video conference on the secondary screen to: invite one or more contacts in the list or accept an invitation from a contact in the list.

7. The television system of claim 6, wherein:
each contact in the list is associated with the following information stored in the memory:
picture, name, phone number, alphanumeric address to be used to launch a video conference involving the contact;
the video conferencing application uses video conferencing related data to enable an interaction with the user on the secondary screen;
the video conferencing related data includes: current television users, video conference contacts for the current television users, video conferencing user profiles for the current television users; and
each video conferencing user profile for a corresponding television user includes: video conference preferences, subscriptions, and other information used to set up and launch video conferences for the corresponding television user.

8. The television system of claim 7, wherein the processor is configured to:
while displaying the first content on the primary screen:
determine a closed captioning language based on configured language information for television users stored in the memory and the current television users, and
display closed captioning data on the secondary screen based on the closed captioning language.

9. The television system of claim 1, wherein:
the primary screen is located above the secondary screen in the housing;
the primary screen and the secondary screen are located on two television panels respectively;
the two television panels are integrated in the housing; and
the two television panels are separated by a sound bar in the housing.

10. The television system of claim 1, wherein:
the primary screen is located above the secondary screen in the housing;
the primary screen and the secondary screen are integrated on a single television panel in the housing; and
the single television panel is divided into the primary screen and the secondary screen by a physical screen divider or a software configuration divider.

11. The television system of claim 1, wherein the processor is configured to:
while displaying the first content on the primary screen:
display software widgets on the secondary screen together with the video conference, wherein at least one of the software widgets is displayed next to the video conference on the secondary screen, and
display an advertising widget on the secondary screen together with the video conference, wherein the advertising widget is displayed next to the video conference on the secondary screen.

12. The television system of claim 1, further comprising:
a camera configured to: determine a quantity of current users of the television, identify the current users, permit video conferencing, and gesture and motion recognition of the current users;
a microphone for capturing sound and voice commands from the current users of the television;
a wireless communication port configured to receive signals and user commands from a remote control for controlling both the primary and secondary screens; and
at least one audio-video port configured to convey the first content and the second content, wherein the user input device includes at least one of the microphone and the remote control.

13. The television system of claim 1, wherein the processor is configured to:
while displaying the first content on the primary screen and displaying the video conference on the secondary screen:
receive an audio gain adjustment command from the user input device, the audio gain adjustment command indicating a user desire to adjust percentages of audio volumes allocated for the first content on the primary screen and the video conference on the secondary screen, respectively, and
adjust the audio volumes for the first content on the primary screen and the video conference on the secondary screen based on the audio gain adjustment command, to provide a blended audio output for both the primary and secondary screens.

14. A method for operating a television system, comprising:
displaying first content on a primary screen, the first content including linear digital content; and
while displaying the first content on the primary screen:
displaying a video conferencing application on a secondary screen to a user, wherein the primary screen and the secondary screen are integrated in a housing of the television system,
determining a video conferencing configuration associated with the user, in accordance with a determination that the video conferencing application is active,
presenting one or more video conferencing options to the user on the secondary screen based on the video conferencing configuration,
receiving a video conference launch command from a user input device of the television system, the video conference launch command indicating a selection of the user regarding the one or more video conferencing options, and
launching a video conference on the secondary screen based on the video conference launch command.

15. The method of claim 14, wherein the video conferencing application is determined to be active based on at least one of:
a video conferencing activation command received from the user input device, the video conferencing activation command indicating a user desire to activate the video conferencing application; and
an incoming video conferencing call received through a port of the television system.

16. The method of claim 14, further comprising:
while displaying the first content on the primary screen:
presenting one or more interactive video conference features to the user on the secondary screen,
receiving a video conference interaction command from the user input device, the video conference interaction command indicating an interactive video conference feature selected by the user, and
performing a video conference function associated with the interactive video conference feature on the secondary screen based on the video conference interaction command.

17. The method of claim 14, further comprising:
while displaying the video conference on the secondary screen:
receiving a television control command from the user input device, the television control command indicating a user desire to control or change the first content on the primary screen, and
performing a television control function to control or change the first content on the primary screen based on the television control command.

18. The method of claim 14, further comprising:
while displaying the video conference on the secondary screen:
receiving an automatic switch command from the user input device, the automatic switch command indicating a user desire to automatically switch content displayed on the primary screen between the linear digital content and video conference related content,
automatically switching the content displayed on the primary screen from the linear digital content to the video conference related content, in accordance with a determination that a predetermined function is activated in the video conference, and
automatically switching the content displayed on the primary screen from the video conference related content to the linear digital content, in accordance with a determination that the predetermined function is deactivated in the video conference, wherein the predetermined function is one of: a screen sharing function, an active speaker displaying function, a notification function, an incoming call function.

19. The method of claim 14, further comprising:
while displaying the first content on the primary screen:
displaying software widgets on the secondary screen together with the video conference, wherein at least one of the software widgets is displayed next to the video conference on the secondary screen, and
displaying an advertising widget on the secondary screen together with the video conference, wherein the advertising widget is displayed next to the video conference on the secondary screen.

20. The method of claim 14, further comprising:
while displaying the first content on the primary screen and displaying the video conference on the secondary screen:
receiving an audio gain adjustment command from the user input device, the audio gain adjustment command indicating a user desire to adjust percentages of audio volumes allocated for the linear digital content on the primary screen and the video conference on the secondary screen, respectively, and
adjusting the audio volumes for the linear digital content on the primary screen and the video conference on the secondary screen based on the audio gain adjustment command, to provide a blended audio output for both the primary and secondary screens.
